(19) United States
(12) Patent Application Publication
(10) Pub. No.: US 2022/0327399 A1
(43) Pub. Date: Oct. 13, 2022

(54) PROBLEM DECOMPOSITION IN A LARGE SCALE COMPLEX COMBINATORIAL PROBLEM

(71) Applicant: FUJITSU LIMITED, Kawasaki-shi (JP)

(72) Inventors: Wei-Peng CHEN, Fremont, CA (US); Hiroyasu KAWANO, Sunnyvale, CA (US)

(73) Assignee: FUJITSU LIMITED, Kawasaki-shi (JP)

(21) Appl. No.: 17/219,626

(22) Filed: Mar. 31, 2021

(51) Int. Cl. G06N 5/04

(52) U.S. Cl. CPC G06N 5/04

(57) ABSTRACT

A method and system of solving a large-scale complex combinatorial problem including receiving the large-scale complex combinatorial problem as an input, converting a decision variable space of the large-scale complex combinatorial problem into a plurality of basic attribute units which correspond to a subset of total decision variables of the large-scale complex combinatorial problem, decomposing the large-scale complex combinatorial problem into a plurality of sub-problems of the plurality of basic attribute units, using a optimization solver, solving the plurality of sub-problems in parallel, outputting a plurality of candidate solutions corresponding to the solutions of the plurality of sub-problems, and using a optimization solver and the plurality of candidate solutions, solving the large scale complex combinatorial problem.

### FIELD OF THE INVENTION

The embodiments discussed in the present disclosure are related to methods and systems for decomposing a large scale complex combinatorial problem.

### BACKGROUND

Many industries require decisions which are discrete choices. These choices fall into the scope of combinatorial optimization problems. Combinatorial Optimization is a subfield of mathematical optimization having a number of real-world and practical applications related to operations research, algorithm theory, and computational complexity theory. It has important applications in several fields, including artificial intelligence, machine learning, auction theory, software engineering, applied mathematics and theoretical computer science. Given the number of applications in a variety of different fields, there is a high demand for combinatorial optimization solvers.

Typically, these solvers are used to address large scale problems, which contain a large number of decision variables. Given the size of the problems, however, and the number of variables, there can be difficulty finding optimization solvers which are capable of providing the hardware solutions and/or computational power provided by the software implementation required to solve large scale combinatorial optimization problems. Further, even when such solvers are available, they may be too costly to be practically or easily implemented.

Examples of conventional optimization solvers include the Cplex™ Optimizer or the Gurobi™ Solver, open source software solvers such as SCIP, as well as newly emerging Quantum-inspired computing machines including simulated annealing machines such as the Fujitsu Digital Annealer™. As previously discussed, however, despite the availability of these systems, such machines still have capacity limitations in their hardware and/or software implementations which may limit the scale of the problems they are capable of solving. For example, such systems may have limitations in the number of binary variables which may be solved. As may be understood, these limitations in turn limit the practical applications that the combinatorial optimization problems are attempting to solve. For example, the D-Wave 2000Q™ quantum computer supports up to 2,048 Qbits, and the Fujitsu Digital Annealer™ supports up to 8,192 Qbits.

One example of a system and method that are currently used for solving a large scale combinatorial optimization problem has been developed by D-Wave in the Qbsolve, which is a decomposing solver which finds a minimum value of a large quadratic unconstrained binary optimization (QUBO) by splitting it into pieces. The pieces are solved using a classical solver running the tabu algorithm. As may be understood by one of skill in the art, however, the tabu based approach only provides a generic solution for the large scale problem and a novel solution is required.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF SUMMARY

According to an aspect of the invention described herein, a computer-implemented method of solving a large-scale complex combinatorial problem is described. The method includes receiving the large-scale complex combinatorial problem as an input, converting the large-scale complex combinatorial problem into a plurality of basic attribute units which correspond to a subset of total decision variables of the large-scale complex combinatorial problem, decomposing the plurality of basic attribute units into a plurality of sub-problems, using a optimization solver, solving the plurality of sub-problems in parallel, outputting a plurality of candidate solutions corresponding to the solutions of the plurality of sub-problems, and using a optimization solver and the plurality of candidate solutions to solve the large scale complex combinatorial problem.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

The embodiments Example embodiments will be described and explained with additional specificity and detail through the use of the accompanying drawings in which:

FIG. 1 is a diagram representing an example environment related to performing decomposition of a large-scale complex combinatorial problem in accordance with some embodiments of the invention;

FIG. 2 is a three-dimensional graph illustrating s set of production schedules as an example of a large-scale complex combinatorial problem in accordance with some embodiments of the invention;

FIG. 3 is a block diagram illustrating a method of decomposing and solving a large-scale combinatorial problem according to some embodiments in accordance with some embodiments of the invention;

FIG. 4 is a block diagram illustrating a method of performing pre-processing of a large-scale combinatorial problem according to some embodiments in accordance with some embodiments of the invention; and

FIG. 5 is a block diagram illustrating a method of decomposing a large-scale combinatorial problem according to some embodiments in accordance with some embodiments of the invention.

### DESCRIPTION OF EMBODIMENTS

The embodiments discussed in the present disclosure are related to methods and systems for decomposing a large-scale complex combinatorial problem in a computing device. More specifically, embodiments described herein are directed to systems and methods for decomposing a mathematical equation that is input. The equation is decomposed into a series of smaller sub-problems, which may then be solved to generate multiple best candidates, which may then be used to solve the large-scale complex combinatorial problem. As is described more fully below, by reducing the number of decision variables in the various sub-problems, different optimization solvers may be used to find solutions to the large-scale complex problem because the processing power required to solve the remaining sub-problems is below the capacity limit of the solvers. As may be understood, using the methods and systems described herein, it is possible to decompose even large-scale complex combinatorial problems efficiently and effectively. Because large-scale complex combinatorial problems have a wide variety of practical applications in a variety of different fields, the ability to efficiently and effectively solve such problems provides benefits not currently available.

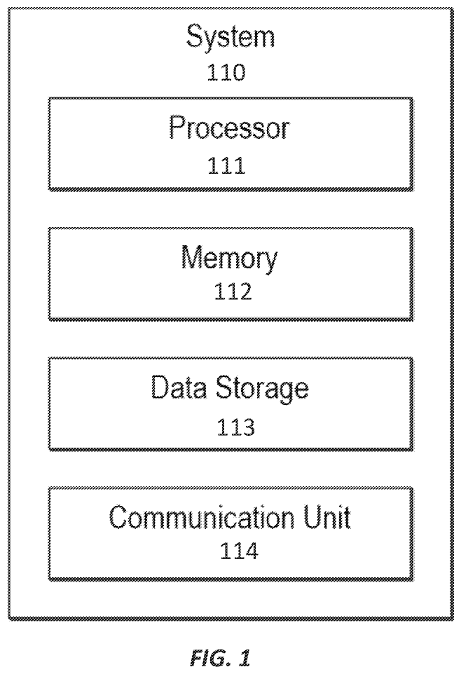

FIG. 1 illustrates a block diagram of an example computing system 110 configured to decompose and solve large-scale complex combinatorial problems, which in some instances may include production scheduling problems, according to at least one embodiment of the present disclosure. The computing system 110 may be configured to implement or direct one or more operations associated with decomposing a large-scale complex combinatorial problem into a series of sub-problems which may then be solved without exceeding the computational capacity of the computing system 110.

The computing system 110 may be or may be used in association with a digital annealer solver, such as a digital annealer solver offered by Fujitsu®. Alternately or additionally, the computing system 110 may comprise or be used in associated with combinatorial optimization solvers such as Cplex, Gurobi, among others. Alternately or additionally, the combinatorial optimization may be solved using heuristics such as the Tabu search or simulated annealing. Alternately or additionally, the combinatorial optimization may be solved using constrained satisfiability (SAT) solvers, such as the SAT solvers provided in Google's OR tool.

The computing system 110 may include a processor 111, a memory 112, and a data storage 113. The processor 111, the memory 112, the data storage 113, and a communication unit 114 may be communicatively coupled, which enables the computing system 110 to communicate with other computing devices.

In general, the processor 111 may include any suitable special-purpose or general-purpose computer, computing entity, or processing device including various computer hardware or software modules and may be configured to execute instructions stored on any applicable computer-readable storage media. For example, the processor 111 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 1, the processor 111 may include any number of processors configured to, individually or collectively, perform or direct performance of any number of operations described in the present disclosure. Additionally, one or more of the processors may be present on one or more different electronic devices, such as different servers.

In some embodiments, the processor 111 may be configured to interpret and/or execute program instructions and/or process data stored in the memory 112, the data storage 113, or the memory 112 and the data storage 113. In some embodiments, the processor 111 may fetch program instructions from the data storage 113 and load the program instructions in the memory 112. After the program instructions are loaded into memory 112, the processor 111 may execute the program instructions.

The memory 112 and the data storage 113 may include computer-readable storage media for carrying or having computer-executable instructions or data structures stored thereon. Such computer-readable storage media may include any available non-transitory media that may be accessed by a general-purpose or special-purpose computer, such as the processor 111. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store particular program code in the form of computer-executable instructions or data structures and which may be accessed by a general-purpose or special-purpose computer. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

Combinations of the above may also be included within the scope of computer-readable storage media. Computer-executable instructions may include, for example, instructions and data configured to cause the processor 111 to perform a certain operation or group of operations.

Modifications, additions, or omissions may be made to the computing system 110 without departing from the scope of the present disclosure. For example, in some embodiments, the computing system 110 may include any number of other components that may not be explicitly illustrated or described.

### Practical Application: Production Scheduling

Although the system and methods described herein may be used in a variety of different settings and applications, the problems which can arise and which may be solved and alleviated will be described with respect to production scheduling. As may be understood by one of skill, production scheduling problem is one of the key problems in supply chain management, and moreover production scheduling problems typically comprise large-scale complex combinatorial problems which are often too large to be solved.

More particularly, in the problem of production scheduling as manufacturer companies receive orders from their customers which specify the quantity of demands, the companies need to plan the production scheduling to meet the demands with consideration of stock management. In order to do so, companies prepare a list of candidate production schedules including the details of scheduling, such as which machine at which factory should be used to manufacture a particular product model of a given product during a specified time. The given scheduling may also include the quantity of each product model which may be manufactured at a given time at a particular factory or on a particular machine. The problem of production scheduling problem is to select the set of production schedules to satisfy demands while minimizing the cost of selected production schedules. In such an instance, multiple variables exist in such a problem, such as identifying which of many available factories, machines, and/or workers should be assigned to the task of producing the product, the time spent to produce the goods, the timing at which it should be performed. As may be understood, in a particular application, additional variables may also be required.

In one instance, the given inputs may include:
K production schedules to be chosen (one binary variable for each schedule) where K is a large number exceeding the capability limit of solver,
One schedule, which includes the detailed production schedule (machine and period) and amount of the product produced by a particular machine along with specific product model it produces,
M factories, with each factory m having a number of machines [symbol] ₘ represents the set of machines {b} at the factory m.
For any machine at any time only one schedule can use it.

There are N types of products. Each type of products n may have multiple product models. Cₙ represents the set of product models belong to product n.

In this example, one schedule may include a span of multiple machines located at different factories. For instance, one product model of a machine can be used as components of another product model manufactured at another machine. At the same time, for any one machine at any given time, only one schedule may control the use of the machine.

In this example, the objective function is to minimize the sum of the cost of the selected production schedules and the penalty of the following considerations for a given period of time T:
(P1) Compliant with long term production plan: the constraint is to ensure the final production matches to the predicted production plan over the d-th segment of given period T as close as possible. The penalty is computed based on the deviation of the total delivery of each product model c over the d-th segment of given period T against the initial target r_{c, d}. For instance, a company may take a segment as monthly basis or quarter basis.
(P2) Compliant with factory production plan: To consider the resource (machine and labor) allocation at each factory, the constraint is to ensure the final production matches to the predicted production plan of each product model c at each factory m. The penalty is computed based on the deviation of the final amount of each product type n at each factory m during the entire period T against the initial target q_{n, m}.
(P3) Compliant with short term stock management plan: To consider the short term variation in stock of each product type n against the targeted stock level at a particular day t, the penalty is computed based on the deviation of the accumulative stock of each product model c at each factory m against the targeted stock level on day t. Both the daily predicted demand d_{c, m,t} of a product model c at each factory m at day t and the targeted stock level p_{c, m,t} of a product model c at each factory m at day t are specified.

The above objective function is subject to the following constraints:
(C1) Conflict in machine scheduling: Candidates of the optimized production schedule which use the same machine at the same time may be generated. To avoid such a conflict from occurring, a constraint of no more than one schedule occupy the same machine is applied. Q_{b, t} represents the set of schedules use the machine b at the day t.

The optimization formulation based on the described problem may be written as:

$$min {\sum }_{k ∈ K} {V}_{k} {x}_{k} + {P}_{1} {\sum }_{d ∈ D ; c ∈ C} {( {\sum }_{k ∈ K} {h}_{d , c , k} {x}_{k} - {r}_{c , d} )}^{2} + {P}_{2} {\sum }_{n ∈ ; m ∈} {( {\sum }_{k ∈ K} {g}_{n , m , k} {x}_{k} - {q}_{n , m} )}^{2} + {P}_{3} {\sum }_{c ∈ C ; m ∈} {\sum }_{t ∈ T} {( {\sum }_{{t}^{′} = 0}^{t} {\sum }_{k ∈ K} {f}_{c , m , {t}^{′} , k} \cdot {x}_{k} - {\sum }_{{t}^{′} = 0}^{t - 1} {d}_{c , m , t} - {p}_{c , m , t} )}^{2}$$

$$subject to$$

$${x}_{{k}_{1}} + {x}_{{k}_{2}} \leq 1 \\ ⋁ {k}_{1} , {k}_{2} ∈ {Q}_{b , t} ; b ∈ ; t ∈$$

Where:
Vₖ is the cost associated with production schedule k,
xₖ is the binary variable to represent each candidate of production schedule k,
P₁, P₂, P₃ are constants applying to the deviation of predefined targets to determine the penalties corresponding to abovementioned compliances (P1)-(P3),
h_{d,c,k} is the amount of delivery for product model c during the d-th segment by production schedule k,
g_{n,m,k} is the amount of delivery for product type n at factory m during the entire period T by production schedule k, and
f_{c,m,t,k} is the amount of delivery for product model c at factory m at day t by production schedule k.

As may be realized by one of skill, however, the size of binary variables K in the problem described above results in a problem which is too large for a computerized solver to solve.

As may be understood, the production scheduling problem may be described as a vector space of decision variables. More specifically, one binary variable xₖ may be used to represent each candidate of production schedule k. When a production schedule candidate k is selected, the decision variable xₖ is set to be 1; otherwise, the decision variable xₖ is set to be 0. As each production schedule is associated with multiple attributes, including factory(s) m, product type(s) n, product model(s) c, machine(s) to use b, product completion date(s) t, segment of the period d, etc. Hence, the problem can be represented in a vector space of variables having a multi-dimensional space, where the number of dimensions corresponds to the number of attributes. In the previously described example, the problem may be represented in a six-dimensional vector space.

One problem, however, is that in this problem some attributes are correlated with each other. When the relationship of multiple-to-one mapping exist in the correlated attributes, the attribute of coarse granularity can be “hidden” as the value of coarse attribute can be found via the correlated and finer-granularity attribute.

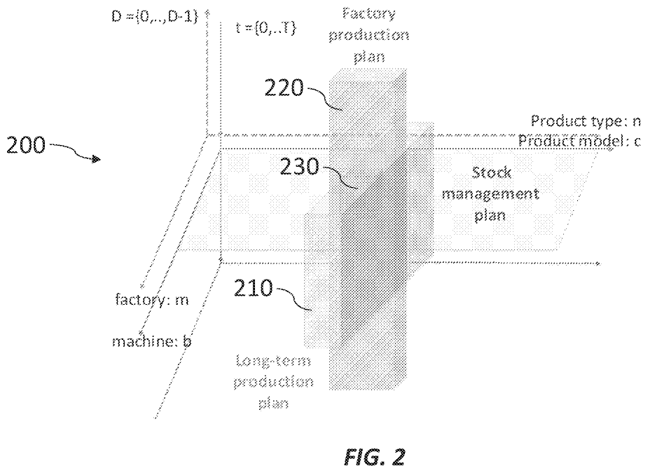

For example, in the production scheduling problem, it can be determined that there are 3 pairs of multi-to-one mapping relationships among 6 attributed considered, including: multiple product models may belong to one product type, multiple machines may belong to one factory, and multiple days may belong to one segment of the entire period. Therefore, the vector space can be simplified to be shown as 3 dimensional space 200, as is shown in FIG. 2. The three-dimensional vector space 200 corresponds to [time (production date, production segment), product (type and model), location (factory and machine)].

Each 3D graph block shown in FIG. 2 represents a set of production schedules which are associated with the attributes corresponding to those in the block. For example, the production schedules which are associated with long term production plan of product model c over the d-th segment of given period T are shown are shown as block 210 in the vector space 200 shown in FIG. 2, the production schedules which are associated with factory production plan of product model c at factory m are shown are shown as block 220, and the production schedules which are associated with short term stock management plan of product type n against the targeted stock level at a particular day t are shown as block 230.

For instance, if a production schedule k visits a factory m, then production schedule k is included into the block containing the factory attribute m. All the candidates of production schedules are included in the whole set {M,N,T} block.

As was previously described, because the total production schedule number K is a large number, it likely exceeds the capacity limit of solver to handle. As such, there is a need to decompose the problem into smaller problems so that the smaller problems, and consequently, the larger problems may be solved.

### Decomposing and Solving the Large Scale Complex Combinatorial Problem

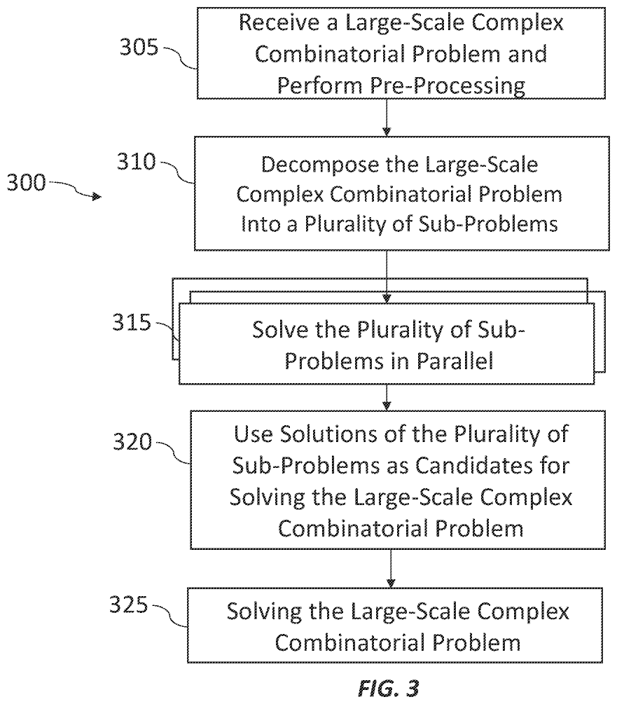

FIG. 3 is a flowchart of an example method 300 for decomposing and solving large scale combinatorial optimization problems, according to at least one embodiment described in the present disclosure. The method 300 may be performed by any suitable system, apparatus, or device. For example, as is described more fully below, one or more operations of the method 300 may be performed by one or more elements of the computing system 110 of FIG. 1 or multiples of the computing system 100 of FIG. 1. More particularly, it should be understood that although illustrated with discrete blocks, the steps and operations associated with one or more of the blocks of the method 300 may be divided into additional blocks, combined into fewer blocks, or eliminated, depending on the particular implementation.

The method 300 begins at block 305, where input data of the production scheduling problems is received by the computing system 110. In addition, at block 305, pre-processing is performed on the input data to identify a set of basic blocks. At block 310, the problem is decomposed at the computing system 110 into a plurality of sub-problems by formulating the problem as a set partition problem solved to achieve minimum interference between the plurality of sub-problems. At block 315, the plurality of sub-problems are solved in parallel by the computing system 110. At block 320, each of the plurality of sub-problems output one or multiple answers are recorded. These answers then serve as the candidates in the final main problem at block 325. More specifically, at block 325 the main problem is solved using the candidates generated by all the plurality of sub-problems and a solution for the production scheduling problem is obtained.

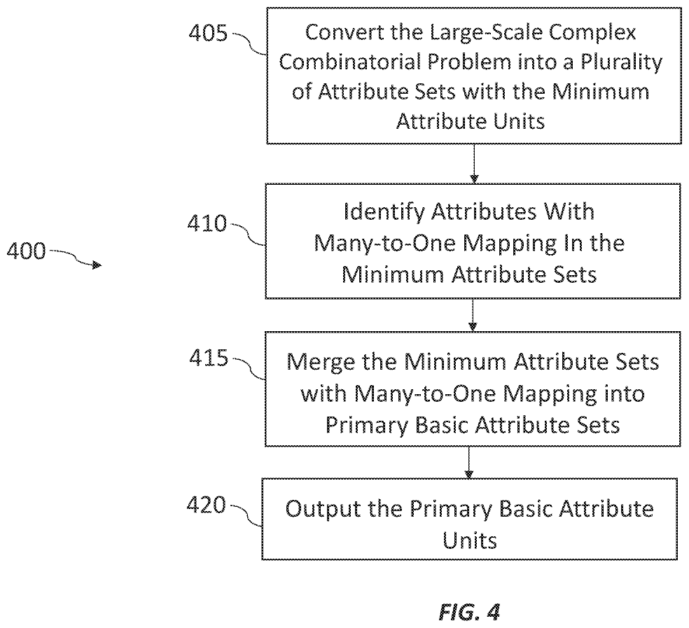

FIG. 4 is a flowchart of an example method 400 illustrating the pre-processing performed at block 305 of FIG. 3, according to at least one embodiment described in the present disclosure. The method 400 may be performed by any suitable system, apparatus, or device. For example, as is described more fully below, one or more operations of the method 400 may be performed by one or more elements of the computing system 110 of FIG. 1 or multiples of the computing system 110 of FIG. 1. Although illustrated with discrete blocks, the steps and operations associated with one or more of the blocks of the method 400 may be divided into additional blocks, combined into fewer blocks, or eliminated, depending on the particular implementation.

The method 400 begins at block 405, where a plurality of attribute sets are constructed with the most basic or minimum attribute units. For example, in the case of production scheduling problem, described above, the production scheduling problem can be constructed into sets of production schedules with the most basic attribute units. In the production scheduling problem, sets of production schedules involved with each minimum basic unit (e.g. date=t, product model c, and machine b) can be constructed, resulting in the following two minimum basic units:

Core sets: C_{t,c,b}=Q_{b,t}∩R_{m,n,t}∩S_{m,c}∀t∈T,c∈ [symbol] ,b∈

[symbol]

Affected sets : A_{t,c,b}=Q_{b,t}∪R_{m,n,t}∪S_{m,c}∀t∈ [symbol] , [symbol] ∈,b∈

[symbol]

where Q_{b,t} represents the set of production schedules involved in machine b and date t, R_{m,n,t} represents the set of production schedules involved in factory m, product type n, and day t, and S_{m,c} represents the set of production schedules involved in factory m, product model c.

At block 410, attributes with many-to-one mapping are identified. At block 415, the minimum basic units are merged into primary basic units when attributes with many-to-one mapping are identified at block 410.

In the case of production scheduling problem, multiple product models {c} are identified at block 410 as belonging to one product type n and multiple machines {b} belong to a single factory m. As a result of this many-to-one mapping, unit of (c,b), the box from (c,b) is merged to the corresponding (n,m) box to form primary basic units described below as the unit of (n,m) is larger than the unit (c,b).

Hence, in the production scheduling problem described above, the two primary basic units are constructed:

Core sets: C_{t,m,n}=∪_{c∈n, b∈m}C_{t,c,b}∀t∈T,m∈M,n∈N

Affected sets: A_{t,m,n}=∪_{c∈n, b∈m}A_{t,c,b}∀t∈T,m∈M,n∈N

As was previously, described after pre-processing is performed, the total production schedule number is K, exceeding the capacity limit of solver to handle, there is a need to decompose the problem into smaller problems.

As previously described, a sub-problem is defined as consideration of a block in the multidimensional-space of variables. In the case of the production schedule problem, the pre-processing has reduced to the 3-D space of [time t, product (type or model) n, and location (machine or factory) m]. A block can be represented as: (T,N,M) where T is a set of time instances t, N is a set of product instances n, M is a set of location instances m. The most basic unit of a block as defined in pre-processing of method 400 is (t, c, b) for a particular day t, product model c, and machine b.

The core sets defined in blocks 405, 410, and 415 determine the necessary production schedules required to be considered within the sub-problems. On the other hand, the affected sets defined in blocks 405, 410, and 415 include any production schedules which are related to the production schedules in the core sets. When the intersection of two affected sets of two blocks is empty, it can be determined that two sub-problems are independent.

As may be understood, the main challenge in decomposing the problem is that the affected sets in the overall space intersect with each other. Consequently, it can be difficult to dissect the 3D or multidimensional space into independent sub-problems.

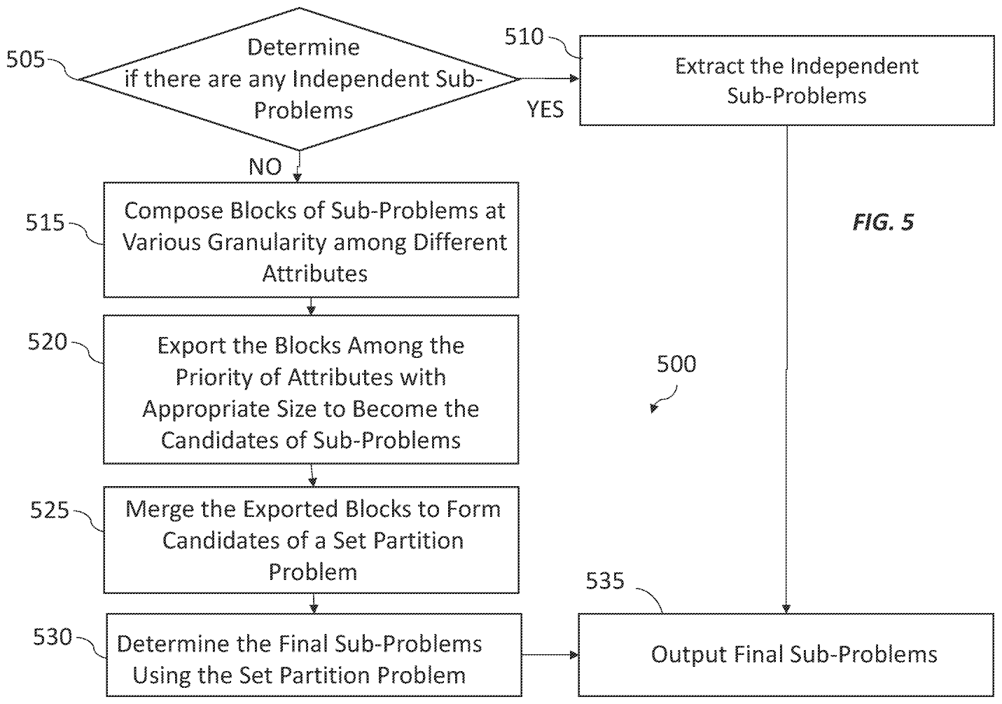

FIG. 5 is a flowchart of an example method 500 for decomposing the scale combinatorial optimization problem as a sub-process of block 310 of FIG. 3, according to at least one embodiment described in the present disclosure. The method 500 may be performed by any suitable system, apparatus, or device. For example, as is described more fully below, one or more operations of the method 500 may be performed by one or more elements of the computing system 110 of FIG. 1 or multiples of the computing system 110 of FIG. 1. Although illustrated with discrete blocks, the steps and operations associated with one or more of the blocks of the method 500 may be divided into additional blocks, combined into fewer blocks, or eliminated, depending on the particular implementation.

The method 500 of decomposing the large-scale complex combinatorial problem begins at block 505, where it is determined if any independent sub-problems exist. In the scheduling problem example, if a block (Tᵢ, Nᵢ, Mᵢ) is identified which does not intersect with other blocks, the block can be removed as an independent block at block 510. In addition, in some instances, to avoid processing a small sub-problem, the size of block is limited to be greater than some value for some attributes. For instance, in the production scheduling problem, the size of time attribute may be required to be at least half of the total period and as such any blocks where the time attribute is less than half the total period may not be considered as independent blocks to be removed at block 510.

In the example of the production scheduling problem, for each attribute, each block with granularity greater than the minimum unit is iterated, and the following algorithm may be used:

If Affected_set (Tᵢ, Nᵢ, Mᵢ)∪Affected_set (T′ᵢ, N′ᵢ, M′ᵢ)=∅, where Tᵢ and T′ᵢ are different sets along the time attribute, Nᵢ and N′ᵢ are different sets along the product attribute, Mᵢ and M′ᵢ are different sets along the location attribute of factories, the set (Tᵢ, Nᵢ, Mᵢ) is retrieved as independent set, and is processed at block 510 as described below.

At block 510, the independent sub-problems are extracted. Further, if the size of an independent sub-problem is large enough to handle, the block (Tᵢ, Nᵢ, Mᵢ) is extracted and stored as one final sub-problem, which is outputted as a final sub-problem at block 535.

At block 515, blocks of sub-problems are composed having various levels of granularity along different attributes. In some instances, composing the blocks of sub-problems comprises merging blocks from the basic blocks to achieve sub-problems with different granularity levels. As may be understood, one objective is to find the appropriate size of sub-problems. Typically, this includes finding sub-problems which are as large as possible without exceeding the computational power of the computing system 110. To do so, the minimum granularity of each attribute is first determined. For instance, in the production scheduling problem, the minimum granularity for time, product, and location may be assigned to be equivalent to half of total period, one factory, and one product model, respectively.

Next, the priority of attributes considered for dissection may be determined. For example, in the example of the production scheduling problem, a priority may be established such that the whole space is dissected according first to product type first, second to factory, third to product model, and time attribute lastly.

Then the core sets may be generated having various granularities of different attributes. This process may include:

1) Generate Coreₙ: the blocks associated with the same product type n: Coreₙ=∪_{d∈D,c∈n,m∈M} Core_{d, c,m,} where d is the index of time attribute (first or second half of the total period).

2) Generate Core_{n,m}: the locks associated with the same product type n and the same factory m: Core_{n,m}=∪_{d∈D,c∈n}Core_{d, c,m}

3) Generate Core_{c,m}: the blocks associated with the same product model c and the same factory m: Core_{c,m}=∉_{d∈D} Core_{d, c,m}

4) Generate Core_{d, c,m}: the blocks associated with the same time period d, the same product model c and the same factory m: Core_{d, c,m}=∪_{t∈{T}_{_{d}}_{}}Core_{t, c,m}

Returning now to FIG. 5, at block 520, the blocks are exported along the priority of attributes with appropriate size to become the candidates of sub-problems. During this process, the maximal sub-problem size (i.e. the maximal number of binary variables able to be handled by the solver) is determined and defined as TH.

Returning to the production scheduling problem, exporting the blocks along the priority of attributes in the order described above of product type, factory, product model, half time period, and days, the blocks can be exported as described below:

1. Sort |Coreₙ| as ascending order

2. If |Coreₙ|<TH, export Coreₙ as a candidate of sub-problem; else steps 3-4

3. Sort |Core_{n,m}| as ascending order

4. If |Core_{n,m}|<TH, export Core_{n,m}| as a candidate of sub-problem; else steps 5-6

5. Sort |Core_{c,m}| as ascending order

6. If |Core_{c,m}|<TH, output Core_{c,m} as a candidate of a sub-problem; else step 7-8

7. Sort |Core_{d,c,m}| as ascending order

8. If |Core_{d,c,m}|<TH, output Core_{d,c,m} as a candidate of sub-problem else step 9;

9. Merge consecutive t belong to the same half period d such that the union of the merge size is less then TH. The merged set is then exported as a candidate of a sub-problem, as is described more fully below.

An example of an output that may be generated according to the steps described above using the production scheduling problem as the example, where the first 24 of total 124 sets are evaluated and the output is in the form of (time, c, m) is shown below:

| | |
|---|---|
| 0:[(T,[37],[0, 1, 2, 3]] | Size 0: 274 |
| 1:[(T,[3, 36, 52],[0]] | Size 1: 780 |
| 2:[(T,[3, 36, 52],[3]] | Size 2: 1030 |
| 3:[(T,[3, 36, 52],[1]] | Size 3: 1310 |
| 4:[(T,[3, 36, 52],[2]] | Size 4: 1397 |
| 5:[(T,[22, 24, 28, 31, 43, 49, 60],[1]] | Size 5: 818 |
| 6:[(T,[22, 24, 28, 31, 43, 49, 60],[3]] | Size 6: 1573 |
| 7:[(T,[22, 24, 28, 31, 43, 49, 60],[2]] | Size 7: 2953 |
| 8:[(T,[10, 21],[0]] | Size 8: 1120 |
| 9:[(T,[10, 21],[2]] | Size 9: 1357 |
| 10:[(T,[10, 21],[1]] | Size 10: 2210 |
| 11:[(T,[10, 21],[3]] | Size 11: 2484 |
| 12:[(T,[8, 19, 32, 44, 51, 58],[0]] | Size 12: 1070 |
| 13:[(T,[8, 19, 32, 44, 51, 58],[1]] | Size 13: 1630 |
| 14:[(T,[8, 19, 32, 44, 51, 58],[3]] | Size 14: 1840 |
| 15:[(T,[8, 19, 32, 44, 51, 58],[2]] | Size 15: 3164 |
| 16:[(T,[6, 12, 25, 27, 35, 42],[0]] | Size 16: 920 |
| 17:[(T,[6, 12, 25, 27, 35, 42],[1]] | Size 17: 2949 |
| 18:[(T,[5, 15, 50],[3]] | Size 18: 2975 |
| 19:[(T,[5, 15, 50],[0]] | Size 19: 3049 |
| 20:[(T,[2, 7, 9, 16, 29, 34, 39, 41, 45, 46, | Size 20: 1680 |
| 48, 53, 54, 55, 56, 57, 59],[0]] | |
| 21:[(T,[2, 7, 9, 16, 29, 34, 39, 41, 45, 46, | Size 21: 2780 |
| 48, 53, 54, 55, 56, 57, 59],[1]] | |
| 22:[(1H,[23],[3]] | Size 22: 1488 |
| 23:[(2H,[23],[3]] | Size 23: 2900 |

Returning to the method 500 shown in FIG. 5, at block 525 the sets are merged to form candidates of a “set partition” algorithm. In the production scheduling problem, the initial max production schedule number may be set as the value of TH (e.g. 8,000).

To merge the sets, all the generated candidates of sub-problems (set S 32 [Sᵢ]), which in this instance is the output of block 520 are inputted. In the production scheduling problem, this includes:

1) The sets of Coreₙ where |Coreₙ|<TH

2) If n′(∀ n′ ∈ N) not covered in 1), the sets of Core_{n′,m} where |Core_{n′,m}|<TH

3) If c′(∀ c′ ∈ n′), m′ (∀ m′ ∈ M) not covered in 1) and 2), the sets of Core_{c,m′} where |Core_{c,m′}|<TH

4) If c′(∀ c′ ∈ n′), m″(∀m″∈M), not covered in 1), 2), and 3), the sets of Core_{d,c′,m″} where |Core_{d, c′,m″}|<TH

After the all the candidates of sub-problems have been inputted, combinations are created for any set in listed in 1)-4) above where the merged set is less than TH. In some instances, these sets may be created recursively. The combinations of Sᵢ are enumerated and the candidate sets C for the set partitioning problem are extracted. The set included in C have the merged size between the lower LB and upper bound UB of a problem size. That is,

C={Cⱼ=∪_{S}_{ᵢ}_{∈S}Sᵢ; LB<|Cⱼ|<UB}

The index matrix of the set partitioning algorithm is represented as I=[Iᵢⱼ] where

$${I}_{i , j} = \{ \begin{matrix}1 & if {S}_{i} ⊂ {C}_{j} . \\ 0 & elsewise .\end{matrix}$$

In some embodiments, only candidates that cannot include one more set without exceeding the capacity limit of the solver will be considered. For example, if we start to add set 0, the candidate 0:[0, 1, 2, 3] is acceptable and would be considered but 0:[0, 1, 2] will not be included.

An example of an output that may be generated according to the steps described above at block 525, where there are a total of 7,490 possible combinations representing candidates in a set partition problem where a sample of 21 possible combinations is shown below:

| | |
|---|---|
| 0:[0, 1, 2, 3] | \|Affected_set[0]\| = 82011 |
| 1:[0, 1, 2, 3, 30, 31, 32, 33] | \|Affected_set[1]\| = 82011 |
| 2:[0, 1, 2, 3, 30, 31, 32, 33, 36] | \|Affected_set[2]\| = 82011 |
| 3:[0, 2, 3, 5] | \|Affected_set[3]\| = 81993 |
| 4:[0, 2, 3, 5, 30, 31] | \|Affected_set[4]\| = 82009 |
| 5:[0, 2, 3, 5, 30, 31, 36] | \|Affected_set[5]\| = 82009 |
| 6:[0, 3, 4] | \|Affected_set[6]\| = 81921 |
| 7:[0, 3, 4, 30, 31, 32] | \|Affected_set[7]\| = 81934 |
| 8:[0, 3, 4, 30, 31, 32, 36] | \|Affected_set[8]\| = 81934 |
| 9:[0, 3, 4, 30, 31, 32, 36, 64, 65] | \|Affected_set[9]\| = 81965 |
| 10:[0, 3, 4, 30, 31, 32, 36, 64, 65, 74] | \|Affected_set[10]\| = 82056 |
| 11:[0, 4, 5, 16] | \|Affected_set[11]\| = 81883 |
| 12:[0, 4, 5, 16, 30] | \|Affected_set[12]\| = 81883 |
| 13:[0, 4, 5, 16, 30, 36] | \|Affected_set[13]\| = 81883 |
| 14:[0, 5, 6] | \|Affected_set[14]\| = 81887 |
| 15:[0, 5, 6, 26] | \|Affected_set[15]\| = 82037 |
| 16:[0, 5, 6, 26, 64, 65] | \|Affected_set[16]\| = 82063 |
| 17:[0, 6, 8] | \|Affected_set[17]\| = 81567 |
| 18:[0, 6, 8, 30, 31, 32] | \|Affected_set[18]\| = 82053 |
| 19:[0, 6, 8, 30, 31, 32, 36] | \|Affected_set[19]\| = 82096 |
| 20:[0, 6, 8, 30, 31, 32, 36, 64, 65] | \|Affected_set[20]\| = 82109 |

Returning to FIG. 5, at block 530, the outputs of block 525 are received and a final set of sub-problems are generated from an optimal solution of a set-partition problem. In the production scheduling problem, the outputs are received as:

C={Cⱼ=∪_{S}_{ᵢ}_{∈S}Sᵢ; LB<|Cⱼ|<UB}

An index matrix of the set partitioning algorithm represented as

$$I = [ {I}_{i , j} ] where {I}_{i , j} = \{ \begin{matrix}1 & if {S}_{i} ⊂ {C}_{j} . \\ 0 & elsewise .\end{matrix}$$

A weight vector W=[wⱼ] where wᵢ=|Aⱼ|, i.e. the size of Affected_set of Cⱼ

For example, using the output listed above in the table as the output of block 525, the third set C₃=[0, 2, 3, 5], =>I_{0,3}=I_{2,3}=I_{3,3}=I_{3,5}=1; |A₃|=81993.

Next, at block 530 a “set-partition” problem is formulated to select the “best” decomposition. Let xᵢ represent a binary variable to include whether Cⱼ is selected in the final set of sub-problems. The objective function is to minimize the number of selected sub-problems and minimize the size of “Affected_sets” |Aⱼ|. The constraint is to make sure all the generated sub-problems S during block 520 are covered by the selected sub-problems:

$$min {\sum }_{j} \vert {A}_{j} \vert {x}_{j}$$

$$s . t . {\sum }_{j} \qquad {I}_{i , j} {x}_{j} = 1 \qquad ∀ {S}_{i} ∈ S$$

As a result, Y sub-problems were generated where Y={Cⱼ where xⱼ=1}. At block 535, these final sub-problems are outputted for parallel solving at block 315 of FIG. 3.

Although the previous embodiment describes one method 500 for decomposing the large scale complex combinatorial problem, other variations to the above method 500 may be performed without departing from the intended scope of the claims recited herein. For example, in one alternative embodiment, the vector space may be decomposed with the same granularity of some attributes. For instance, a sub-problem may be considered as covering one unit of Core_{d, c,m} (the blocks associated with the same time period d, the same product model c and the same factory m).

In another embodiment, the order of the attributes that are prioritized in block 530 may be altered. More specifically, in the example described above, the order of attributes prioritized in the division of problem vector space was product, location, and time. It should be understood that other orders could be considered for division. For instance, the vector space could be divided based on the location attribute as a first priority.

In other embodiments, different strategies of decomposition may be used such that the results of different strategies of decomposition may lead to overlaps of decompositions. More specifically, because the solutions of sub-problems only serve as “good candidates,” the good candidates from various decomposition strategies could also be combined together to serve as final candidates of the main problem. In this alternative embodiment, the problem decomposition is herein referred to as a “set covering problem.” In the set covering problem a “set-cover” problem may be formulated to select the “best” decomposition. Let xⱼ represent a binary variable to include Cⱼ in the final set of sub-problems. The objective function is to minimize the number of selected sub-problems and minimize the size of “Affected_sets” |Aⱼ|. The constraint is to make sure all the generated sub-problems S from the algorithm of block 520 are covered by at least one of the selected sub-problems:

$$min {\sum }_{j} \vert {A}_{j} \vert {x}_{j}$$

$$s . t . {\sum }_{j} \qquad {I}_{i , j} {x}_{j} \geq 1 \qquad ∀ {S}_{i} ∈ S$$

Returning to block 320 of FIG. 3, the plurality of sub-problems generated by the problem decomposition are then solved in parallel. The plurality of sub-problems can be treated as independent from each other and therefore, solved simultaneously.

During this parallel solving of the sub-problems, a computational solver may be used to get the top n best answers for each sub-problem. Parameters α below may be set as very small constants, such that, in general, the contribution of the vector space which is not considered is not taken into account in solving a current sub-problem. Instead, only a small weight is used to consider the contribution for the purpose of tie-breaker. The formulation of a subproblem can be represented as below:

$$min {\sum }_{k ∈ {}_{}} {V}_{k} {x}_{k} + {P}_{1} {\sum }_{d = {D}_{} ; c ∈ {C}_{}} {( {\sum }_{k ∈ {}_{}} {h}_{d , c , k} {x}_{k} - {r}_{c , d} )}^{2} + \\ {α}_{1} {P}_{2} {\sum }_{d ∉ {D}_{} ; c ∉ {C}_{}} {( {\sum }_{k ∈ {}_{}} {h}_{d , c , k} {x}_{k} - {r}_{c , d} )}^{2} + {P}_{2} {\sum }_{n ∈ {}_{} ; m ∈ {}_{}} {( {\sum }_{k ∈ {}_{}} {g}_{n , m , k} {x}_{k} - {q}_{n , m} )}^{2} + \\ {α}_{2} {P}_{2} {\sum }_{n ∉ {}_{} ; m ∉ {}_{}} {( {\sum }_{k ∈ {}_{}} {g}_{n , m , k} {x}_{v} - {q}_{n , m} )}^{2} + {P}_{3} {\sum }_{c ∈ {C}_{} ; m ∈} {\sum }_{t ∈ T} {( {\sum }_{{t}^{′} = 0}^{t} {\sum }_{k ∈ {}_{}} {f}_{c , m , {t}^{′} , k} \cdot {x}_{k} - ( {\sum }_{{t}^{′} = 0}^{t - 1} {d}_{n , m , t} ) - {p}_{n , m , t} )}^{2} + {α}_{3} {P}_{3} {\sum }_{c ∉ {C}_{} ; m ∉ {}_{}} {\sum }_{t ∉ {T}_{i}} {( {\sum }_{{t}^{′} = 0}^{t} {\sum }_{k ∈ {}_{}} {f}_{c , m , {t}^{′} , k} \cdot {x}_{k} - ( {\sum }_{{t}^{′} = 0}^{t - 1} {d}_{n , m , t} ) - {p}_{n , m , t} )}^{2}$$

$$subject to$$

$${x}_{{k}_{1}} + {x}_{{k}_{2}} \leq 1 \\ ⋁ {k}_{1} , {k}_{2} ∈ {Q}_{b , t} ; b ∈ ; t ∈$$

An alternative formulation of subproblems can be considered with partial contribution as shown below may be applied:

$$min {\sum }_{k ∈ {}_{}} {V}_{k} {x}_{k} + {P}_{1} {\sum }_{d = {D}_{} ; c ∈ {C}_{}} {( {\sum }_{k ∈ {}_{}} {h}_{d , c , k} {x}_{k} - P C {T}_{1 , d , c} \cdot {r}_{c , d} )}^{2} + {α}_{1} {P}_{1} {\sum }_{d ∉ {D}_{} ; c ∉ {C}_{}} {( {\sum }_{k ∈ {}_{}} {h}_{d , c , k} {x}_{k} - P C {T}_{1 , d , c} \cdot {r}_{c , d} )}^{2} + {P}_{2} {\sum }_{n ∈ {}_{} ; m ∈ {}_{}} {( {\sum }_{k ∈ {}_{}} {g}_{n , m , k} {x}_{k} - P C {T}_{2 , n , m} \cdot {q}_{n , m} )}^{2} + {α}_{2} {P}_{2} {\sum }_{n ∉ {}_{} ; m ∉ {}_{}} {( {\sum }_{k ∈ {}_{}} {g}_{n , m , k} {x}_{v} - P C {T}_{2 , n , m} \cdot {q}_{n , m} )}^{2} + {P}_{3} {\sum }_{c ∈ {C}_{} ; m ∈} {\sum }_{t ∈ T} {( {\sum }_{{t}^{′} = 0}^{t} {\sum }_{k ∈ {}_{}} {f}_{c , m , {t}^{′} , k} \cdot {x}_{k} - {PCT}_{3 , c , m} ( ( {\sum }_{{t}^{′} = 0}^{t - 1} {d}_{n , m , t} ) + {p}_{n , m , t} ) )}^{2} + {α}_{3} {P}_{3} {\sum }_{c ∉ {C}_{} ; m ∉ {}_{}} {\sum }_{t ∉ {T}_{i}} {( {\sum }_{{t}^{′} = 0}^{t} {\sum }_{k ∈ {}_{}} {f}_{c , m , {t}^{′} , k} \cdot {x}_{k} - {PCT}_{3 , c , m} ( ( {\sum }_{{t}^{′} = 0}^{t - 1} {d}_{n , m , t} ) + {p}_{n , m , t} ) )}^{2}$$

$$subject to$$

$${x}_{{k}_{1}} + {x}_{{k}_{2}} \leq 1 \\ ⋁ {k}_{1} , {k}_{2} ∈ {Q}_{b , t} ; b ∈ ; t ∈$$

The result of problem decomposition may cover a subset of vector space considered in some constraints. For instance, the first penalty term P1 considers the accumulative load of a product model c across the entire set of factories. However, a sub-problem may only cover {m}, a subset of the entire set of factories. Therefore, a formulation of partial contribution PCT_{1,d′,c} is applied in the computation of objective function. The formulation of all partial contribution weights are shown below:

$${PCT}_{1 , d , c} = \frac{{q}_{c , m}}{{\sum }_{c ∈ {C}_{}} {\sum }_{m ∈ {}_{}} {q}_{c , m}}$$

$${PCT}_{2 , n , m} = \frac{{r}_{c , d}}{{\sum }_{c ∈ n} {\sum }_{d ∈ {D}_{}} {r}_{c , d}}$$

$${PCT}_{3 , c , m} = \frac{{q}_{c , m}}{{\sum }_{c ∈ C} {q}_{c , m}}$$

As each of the sub-problems are solved during block 320, each sub-problem generates solutions which may be considered as solutions to the final large-scale complex combinatorial problem. In the case of the production scheduling problem, each sub-problem generates a list of production schedules as the candidates to be considered in the final main problem at block 325.

It should be understood that a computational solver such as Digital Annealer may generate multiple answers. Further, some sub-problems could have up to 128 different answers and other has only one answer. In order to control the size of the candidates to be less then TH, a process may be used to identify the best candidates from the candidate pool or to otherwise reduce the size of the potential candidates.

In one embodiment, the algorithm for generating the final candidates may be: Z: Final_candidate_list=[ ]

For n=1 to 128:
For k in all sub-problems:
   Include sub-problem[k].ans[n] into Final_candidate_list
   If the size of Final_candidate_list >TH: break

As may be understood, it may also be possible to consider different strategies to select the final candidates for the final main problem. For instance, the candidates may be selected from a different division of sub-problems. For example, when there are two sets of sub-problems based on two different divisions, the top best candidates generated from each strategy can be considered in the candidates of final main problem.

At block 325, as the size of final candidate set Z is smaller than TH, a optimization solver is then used to solve the main problem:

$$min {\sum }_{k ∈ Z} {V}_{k} {x}_{k} + {P}_{1} {\sum }_{d ∈ D ; c ∈ C} {( {\sum }_{k ∈ Z} {h}_{d , c , k} {x}_{k} - {r}_{c , d} )}^{2} + {P}_{2} {\sum }_{n ∈ ; m ∈} {( {\sum }_{k ∈ K} {g}_{n , m , k} {x}_{k} - {q}_{n , m} )}^{2} + {P}_{3} {\sum }_{c ∈ C ; m ∈} {\sum }_{t ∈ T} {( {\sum }_{{t}^{′} = 0}^{t} {\sum }_{k ∈ Z} {f}_{c , m , {t}^{′} , k} \cdot {x}_{k} - {\sum }_{{t}^{′} = 0}^{t - 1} {d}_{n , m , t} - {p}_{c , m , t} )}^{2}$$

$$subject to$$

$${x}_{{k}_{1}} + {x}_{{k}_{2}} \leq 1 \\ ⋁ {k}_{1} , {k}_{2} ∈ {Q}_{b , t} ; b ∈ ; t ∈$$

As may be understood, using the ability to decompose a large-scale complex combinatorial problem as is described using the system and methods herein, it is possible to efficiently and effectively solve problems which have not previously been able to be easily solved, even using advanced optimization solvers which are currently available in the art. Consequently, the method and systems described herein provide benefits which have not previously been possible and improve existing optimization solvers' ability to process and solve problems. As an example of just one such problem which is now better suited for solution, the production scheduling problem is described herein as a single practical application of the system and methods described herein. It should be understood that other applications may also benefit from the problem decomposition method and system described herein.

Further, it should be understood that as used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A computer-implemented method of solving a large-scale complex combinatorial problem, the method comprising:
receiving the large-scale complex combinatorial problem as an input;
converting a decision variable space of the large-scale complex combinatorial problem into a plurality of basic attribute units which correspond to a subset of total decision variables of the large-scale complex combinatorial problem;
decomposing the large-scale complex combinatorial problem into a plurality of sub- problems of the plurality of basic attribute units;
using an optimization solver, solving the plurality of sub-problems in parallel, outputting a plurality of candidate solutions corresponding to the solutions of the plurality of sub- problems; and
using the optimization solver and the plurality of candidate solutions to solve the large scale complex combinatorial problem.

2. The computer-implemented method of claim 1, wherein converting the decision variable space of the large-scale complex combinatorial problem into the plurality of basic attribute units comprises constructing the plurality of basic attribute units in a vector space corresponding to the total decision variables.

3. The computer-implemented method of claim 1, wherein decomposing the plurality of basic attribute units into a plurality of sub-problems comprises minimizing interference between any two sub-problems.

4. The computer implemented method of claim 3, wherein decomposing the plurality of basic attribute units into a plurality of sub-problems comprises using set partitioning to minimize the interference between any two sub-problems.

5. The computer-implemented method of claim 3, further comprising applying a priority to attributes represented in the plurality of basic attribute units to generate the plurality of sub-problems.

6. The computer-implemented method of claim 3, further comprising sub-problems at various granularity among different attributes of the basic attribute units to generate the plurality of sub-problems.

7. The computer implemented method claim 1, wherein solving the plurality of sub- problems in parallel to output the plurality of candidate solutions comprises identifying multiple best candidates generated from each sub-problem of the plurality of sub-problems.

8. The computer implemented method of claim 1, wherein the computing processing power required to solve each of the plurality of sub-problems and the large-scale complex combinatorial problem is below a predetermined threshold of the optimization solver.

9. The computer implemented method of claim 1, wherein the large-scale complex combinatorial problem includes a production scheduling problem for generating production schedules directing which resources and facilities should be directed at producing a given product at a particular time.

10. One or more computer-readable media configured to store instructions that when executed by a system cause or direct the system to perform actions, the actions comprising:
receiving a large-scale complex combinatorial problem as an input;
converting a decision variable space of the large-scale complex combinatorial problem into a plurality of basic attribute units which correspond to a subset of total decision variables of the large-scale complex combinatorial problem;
decomposing the large-scale complex combinatorial problem into a plurality of sub- problems of the plurality of basic attribute units;
solving the plurality of sub-problems in parallel, outputting a plurality of candidate solutions corresponding to the solutions of the plurality of sub-problems; and
using the plurality of candidate solutions to solve the large scale complex combinatorial problem.

11. The one or more computer-readable media of claim 10, wherein converting the decision variable space of the large-scale complex combinatorial problem into the plurality of basic attribute units comprises constructing the plurality of basic attribute units in a vector space corresponding to the total decision variables.

12. The one or more computer-readable media of claim 10, wherein decomposing the plurality of basic attribute units into a plurality of sub-problems comprises minimizing interference between any two sub-problems.

13. The one or more computer-readable media of claim 12, wherein decomposing the plurality of basic attribute units into a plurality of sub-problems comprises using set partitioning to minimize the interference between any two sub-problems.

14. The one or more computer-readable media of claim 10, wherein solving the plurality of sub-problems in parallel to output the plurality of candidate solutions comprises identifying multiple best candidates generated from each sub-problem of the plurality of sub-problems.

15. The one or more computer-readable media of claim 10, wherein the computing processing power required to solve each of the plurality of sub-problems and the large-scale complex combinatorial problem is below a predetermined threshold of the system.

16. The one or more computer-readable media of claim 10, wherein the large-scale complex combinatorial problem is a production scheduling problem for generating production schedules directing which resources and facilities should be directed at producing a given product at a particular time.

17. A system comprising:
one or more computer-readable storage media configured to store instructions; and
one or more processors communicatively coupled to the one or more computer-readable storage media and configured to, in response to execution of the instructions, cause the system to perform operations, the operations comprising:
receiving a large-scale complex combinatorial problem as an input;
converting a decision variable space of the large-scale complex combinatorial problem into a plurality of basic attribute units which correspond to a subset of total decision variables of the large-scale complex combinatorial problem;
decomposing the large-scale complex combinatorial problem into a plurality of sub- problems of the plurality of basic attribute units;
using an optimization solver, solving the plurality of sub-problems in parallel, outputting a plurality of candidate solutions corresponding to the solutions of the plurality of sub-problems; and
using the optimization solver and the plurality of candidate solutions to solve the large scale complex combinatorial problem.

18. The system of claim 17, wherein converting the decision variable space of the large- scale complex combinatorial problem into the plurality of basic attribute units comprises constructing the plurality of basic attribute units in a vector space corresponding to the total decision variables.

19. The system of claim 17, wherein decomposing the plurality of basic attribute units into a plurality of sub-problems comprises minimizing interference between any two sub-problems using set-partitioning.

20. The system of claim 17, wherein the computing processing power required to solve each of the plurality of sub-problems and the large-scale complex combinatorial problem is below a predetermined threshold of the optimization solver.
